(19) United States
(12) Patent Application Publication
(10) Pub. No.: US 2005/0044131 A1
(43) Pub. Date: Feb. 24, 2005

(54) Measuring instrument having web server function

(76) Inventor: Masaaki Nagai, Kanagawa (JP)

Correspondence Address: FISH & RICHARDSON P.C., 1425 K STREET, N.W., 11TH FLOOR, WASHINGTON, DC, 20005-3500, US

(21) Appl. No.: 10/689,536

(22) Filed: Oct. 21, 2003

(30) Foreign Application Priority Data
Oct. 23, 2002 (JP) 308496/2002

(51) Int. Cl. G06F 15/16

(52) U.S. Cl. 709/200

(57) ABSTRACT

A measuring instrument of the present invention having a web server function comprises: a) control means for controlling an operation of the measuring instrument; b) storage means for storing measurement condition data; c) measuring means for performing a measurement based on the measurement condition data; receiving means for receiving request data from a client device; and e) transmitting means for transmitting web data to the client device. The control means a) controls the transmitting means so as to transmit web data corresponding to a remote control web page i) when the request data is request data for requesting transmission of the remote control web page, and the control means a) controls the storage means so as to store the measurement condition data corresponding to the request data ii) when the request data is request data for requesting a setting of a measurement condition.

### BACKGROUND OF THE INVENTION

The present invention relates broadly to the control of a measuring instrument and particularly concerns a measuring instrument permitting a client device to perform remote control and remote monitoring.

Conventionally, when a measuring instrument is remotely controlled or monitored by a client device, dedicated interfaces are provided on both, the measuring instrument as well as the client device, and the transmission and reception of data between the interfaces are controlled by dedicated interface software.

The disadvantage in this system is that the development costs of the required dedicated interface software (remote control software) for the client device would be high.

As described in Patent Document 1, the following method has been known: a web server is provided between a measuring instrument and a client device via a general interface, and the transmission and reception of data from the client device to the web server (measuring instrument) is controlled by a typical web browser.

[Patent Document 1]

Japanese Laid-Open Patent No. 2000-46600 (pages 2 to 5, FIGS. 1 and 3)

According to the technique described in Patent Document 1, it is not necessary to develop a remote control software for the client device.

However, the technique described in Patent Document 1 requires that a web server be used in addition to a measuring instrument, resulting in the two problems described below. A first problem is that a large system is required on the side of the measuring instrument. Thus, the technique described in Patent Document 1 is not suitable for a small measuring instrument. For example, in the case of a portable measuring instrument, even when a notebook PC (personal computer) is used as a web server, it is not practical for a user to be mobile when operating in conjunction the measuring instrument and the notebook PC which are connected to each other via a communication cable. A second problem is a considerable burden on the user when a web server is used along with a measuring. For example, a PC serving as a web server has to be handled with far greater care than typical measuring instruments, resulting in restraints on vibrations, on/off of a power supply, and so on.

Further, since the measuring instrument and the web server are connected to each other via a general interface (e.g., RS 232), a third problem arises. The third problem is the necessity for designing a control program for the measuring instrument and the corresponding control program for the web server with due consideration of a communications protocol. Hence, the development of the programs requires high cost.

### SUMMARY OF THE INVENTION

In view of the drawbacks of the prior art as described above, an object of the present invention is to provide a small measuring instrument which can be remotely controlled or monitored by a client device.

Another object of the present invention is to provide a measuring instrument which can be remotely controlled or monitored by a client device with ease of handling.

Additionally, another object of the present invention is to provide an inexpensive measuring instrument which can be remotely controlled or monitored by a client device.

A measuring instrument of the present invention having a web server function comprises: a) control means for controlling an operation of the measuring instrument; b) storage means for storing measurement condition data; c) measuring means for performing a measurement based on the measurement condition data; receiving means for receiving request data from a client device; and e) transmitting means for transmitting web data to the client device.

The control means a) controls the transmitting means so as to transmit web data corresponding to a remote control web page i) when the request data is request data for requesting transmission of the remote control web page, and the control means a) controls the storage means so as to store the measurement condition data corresponding to the request data ii) when the request data is request data for requesting a setting of a measurement condition.

The control means a) creates the web data so that the remote control web page permits a user of the client device to input measurement condition data.

Alternatively, the control means a) may create the web data so that the remote control web page permits a user of the client device to select measurement condition data. The control means a) preferably creates the web data so that the remote control web page further displays an image and coordinates on the image are transmitted as the measurement condition data in response to the user's click on the image.

The control means a) creates the web data so that the remote control web page further displays actually set measurement condition data.

Additionally or alternatively, the control means a) creates the web data so that the remote control web page further displays the image for visualizing actually set measurement condition data.

### BRIEF DESCRIPTION OF THE DRAWINGS

FIG. 1 is a functional block diagram showing a measuring instrument having a web server function according to the present invention;

FIG. 2 is a flowchart showing an example of the operations of the measuring instrument having a web server function according to the present invention;

FIG. 3 is a view showing an example of a remote control web page; and

FIG. 4 is a view showing an example of the remote control web page having omitted a field for inputting measurement conditions.

### DETAILED DESCRIPTION OF THE INVENTION

Following is a description of an embodiment of the present invention with reference to the accompanying drawings.

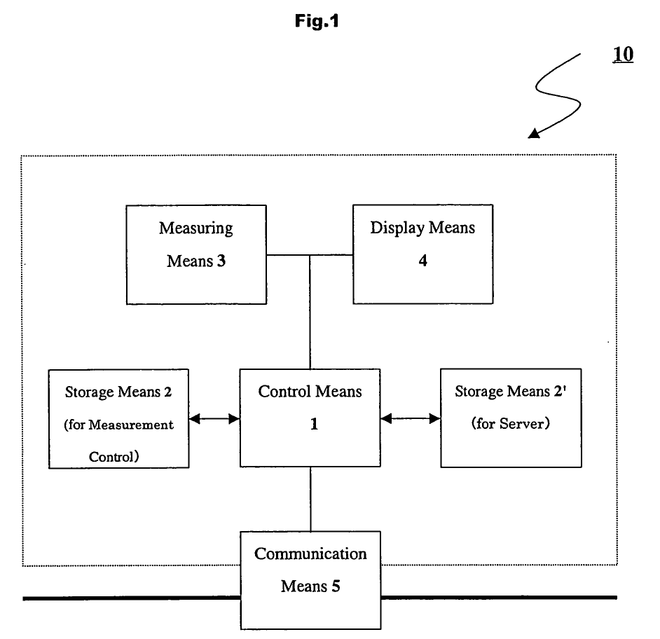

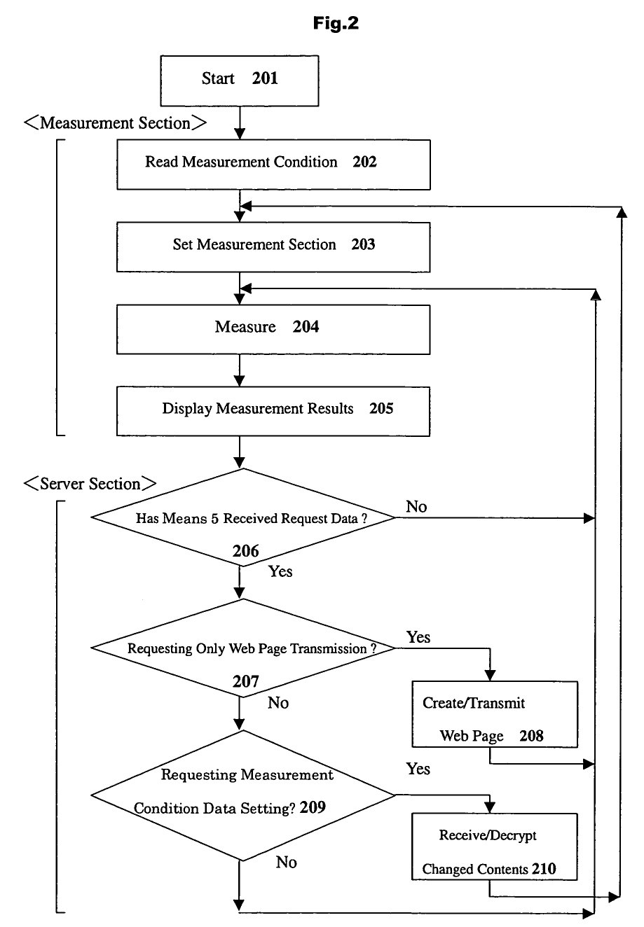

FIG. 1 is a functional block diagram showing a measuring instrument having a web server function according to the present invention. FIG. 2 is a flowchart showing an example of the operations of the measuring instrument.

As shown in FIG. 1, a measuring instrument 10 of the present invention comprises control means 1 for controlling the operations of the measuring instrument, storage means 2 for storing a control program and measuring condition data, measuring means 3 for performing measurements based on the measuring condition data, display means 4 for displaying the measurement results, and communication means 5 for communicating data with a client device.

Moreover, the measuring instrument 10 further comprises storage means 2′ for storing a web server program and web data. Alternatively, the measuring instrument 10 may comprise single storage means having the function of the storage means 2 and the function of the storage means 2′, that is, single storage means having a storage area for a measurement remote control and a storage area for a server.

Referring to FIG. 2, the operations of themeasuring instrument 10 will be specifically described according to the present invention.

First, when the user turns on the measuring instrument 10, the control means 1 (e.g., a CPU) executes a control program stored in the storage means 2 (e.g., a memory) (step 201), reads default measurement condition data, which is stored in the storage means 2 (step 202), based on the control program, and sets the measurement conditions for the measuring means 3 (step 203).

Further, the control means 1 starts a web server program, which is stored in the memory means 2′ (e.g., a memory), based on the control program.

Thereafter, the control means 1 performs control based on the control program so that the measuring means 3 performs a measurement under the set measurement conditions (step 204). When the measuring means 3 performs measurements under the set measurement conditions, the control means 1 performs control based on the control program so that the display means 4 (e.g., an LCD) displays measurement results (step 205).

For example, the measuring instrument 10 is a measuring instrument for measuring a video signal level. To be specific, the control means of this measuring instrument is fed with a video output signal including a luminance signal and a color-difference signal from a video camera for shooting an object, performs RGB processing on the video output signal to create graphic data, and stores the graphic data in the storage means. Thereafter, the measuring means of the measuring instrument measures a video signal level on a position (measurement condition data) specified in the graphic data to create video signal level data, and stores the video signal level data (measurement results) in the storage means. Then, the control means of the measuring instrument creates display data including the graphic data and the video signal level data, and stores the display data in the storage means. Thereafter, the display means of the measuring instrument displays the display data. Note that the present invention is not limited to using measuring instrument 10 but includes a wide variety of typical measuring instruments.

Referring to FIG. 2 again, after that, the control means 1 decides on the basis of the control program and the web server program, whether or not communication means 5 has received request data from the client device via a network (step 206). It does not matter whether the network is wired or wireless. Further, in the case of a wired network, it does not matter whether the network is on a LAN or a telephone line.

When the communication means 5 has not received request data (step 206), the control means 1 controls the measuring means 3 and the display means 4 (steps 204 and 205) to repeat steps 204 and 205 until the communication means 5 receives request data.

When the communication means 5 has received request data (step 206), the control means 1 decides whether the received request data includes only request data for requesting the transmission of a remote control web page (step 207).

For example, the user of the client device designates an IP address, which has been set for the measuring instrument 10, for the web browser of the client device, so that the client device transmits, to themeasuring instrument 10, request data for requesting the transmission of the remote control web page data.

When the request data is provided as request data for requesting the transmission of remote control web page data (step 207), the control means 1 creates, on the basis of the control program, remote control web page data having at least an input field or a selection field for permitting the setting of measurement condition data (step 208). It is preferable that the control means 1 creates remote control web page data for displaying the actually set measurement condition data (step 208).

For example, as expressed by formula 1 below, the remote control web page data is described in HTML or the like so as to display graphic data (“picture. jpg”) on which a marker is added to visualize a measurement position (measurement condition data) on graphic data actually inputted to the measuring instrument 10, numerical data of measurement results (“Y:100%, R:100%, G:100%, B:100%”), and actually set measurement condition data (“x:100 pixels, y:100 pixels”). The web page data is further described so as to cause the user of the client device to input measurement condition data, and transmit request data for requesting the setting of measurement conditions in response to the user's click on a transmission button (“Set”).

(formula 1) :

| <html> | |
|---|---|
| <head> | |
| <title> MEASURE1 </title> | |
| </head> | |
| <body bgcolor=“silver”> | |
| <form name=“measure1” action=“” method=“post”> | |
| <div align=“center”> | |
| <img name=“image” src=“picture.jpg” width=“216” | |
| height=“177” border=0> | |
| <br> | |
| <br> | |
| <tt> | |
| <font color=“#000000”> Y:</font>100% | |
| <br> | |
| <font color=“#ff0000”> R:</font>100% | |
| <br> | |
| <font color=“#009000”> G:</font>100% | |
| <br> | |
| <font color=“#0000ff”> B:</font>100% | |
| <br> | |
| <br> | |
| POSITION = | X:<input type=“text” name=“X” value=“100” size=3 |

maxlength=3>pixel

Y:<input type=“text” name=“Y” value=“100” size=3

maxlength=3>pixel
<br>
<br>
<input type=“reset” value=“CANCEL”>
<input type=“submit” value=“ SET ”>
<br>
</tt>
</div>
</form>
</body>
</html>

Alternatively, as expressed by formula 2 below, the remote control web page data is described in HTML or the like so as to display graphic data (“picture.jpg”) on which a marker is added to visualize a measurement position (measurement condition data) on graphic data actually inputted to the measuring instrument 10, and numerical data of measurement results (“Y:100%, R:100%, G:100%, B:100%”), cause the user of the client device to select measurement condition data, and transmit coordinates on an image as measurement condition data in response to the user's click on the image (“tag: ismap”). In this way, by specifying a point on an actually displayed image, description having omitted a field for inputting measuring condition data can be provided.

(formula 2) :

<html>
<head>
<title> MEASURE2 </title>
</head>
<body bgcolor=“silver”>
<form name=“measure2” action=“” method=“”>
<div align=“center”>
<a href=“/measure2.htm”><img name=“image” src=“picture.jpg”
width=“216” height=“177” ismap border=0></a>
<br>
<br>
<tt>
<font color=“#000000”> Y:</font>100%
<br>
<font color=“#ff0000”> R:</font>100%
<br>
<font color=“#009000”> G:</font>100%
<br>
<font color=“#0000ff”> B:</font>100%
</tt>
</div>
</form>
</body>
</html>

Referring to FIG. 2 again, the control means 1 subsequently performs control based on the web server program so that the communication means 5 transmits remote control web page data (step 208). Note that the communication means 5 transmits web page data, so that the control means 1 decides in step 206 that the communication means 5 has not received request data.

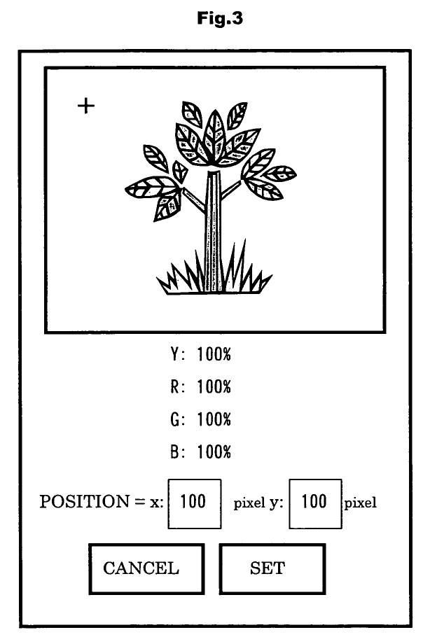

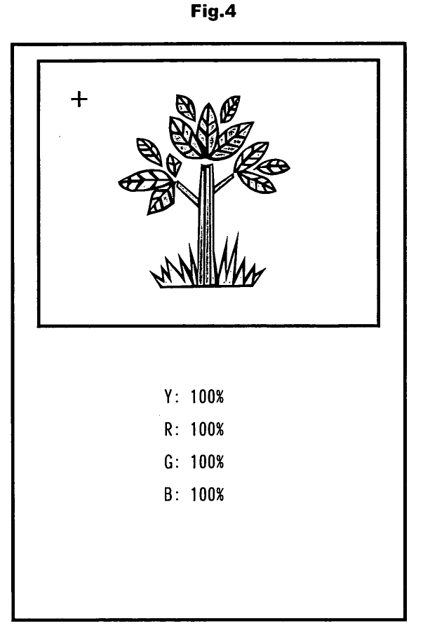

On the other hand, the client device receives remote control web page data and displays remote control web pages of FIGS. 3 and 4 on the display means of the client device. Thereafter, the user of the client device inputs or selects measurement condition data on the remote control web page, so that the client device transmits, to the measuring instrument 10, request data for requesting the setting of the measurement condition data and the transmission of the remote control web page.

When the measurement instrument 10 receives the request data, the control means 1 decides that the communication means 5 has received request data (step 206). Thereafter, the control means 1 decides that the received request data includes data as well as request data for requesting the transmission of a remote control web page (step 207).

Subsequently, the control means 1 decides whether the received request data is provided as request data for requesting the setting of measurement condition data (step 209).

When the request data includes request data for requesting the setting of measurement condition data (step 209), the control means 1 decrypts the request data (step 210) and stores decrypted measurement condition data in the storage means 2 (step 203). Since the measurement condition data is stored, the control means 1 decides in step 207 that the communication means 5 does not request the setting of measurement condition data and has received request data for requesting only the transmission of a remote control web page.

After that, the control means 1 controls the measuring means 3 and the display means 4 by using the measurement condition data changed by the client device (steps 204 and 205). Thereafter, the control means 1 decides that the communication means 5 has received request data (step 206) and the received request data includes only request data for requesting the transmission of a remote control web page (step 207). Next, the communication means 5 (preferably displaying actually set measurement condition data) transmits remote control web page data (step 208) and repeats steps 204 and 205 until the communication means 5 receives request data again.

In this way, according to the measuring instrument 10 of the present invention,since the measuring instrument 10 has a web server function, in other words, the control program and the web server program are executed by the control means (CPU) of the measuring instrument 10, it is not necessary to provide a web server having control means other than the control means of the measuring instrument 10. Thus, a small measuring instrument can be provided. Moreover, a measuring instrument can be provided that can be handled with ease. Further, a storage area for measurement remote control and a storage area for a server are controlled by the control means 1 regardless of whether the control is performed separately or collectively. Therefore, when measurement results are used on the web server side, data requires only movement. Hence, during program development, it is not necessary to take into consideration the communications protocol of a general interface, thereby, making a cost—effective measuring instrument that is inexpensive for the user.

In the present specification, the measurement condition data indicates measurement conditions required for the measurements of a typical measuring instrument.

It should be understood that the measuring instrument 10 according to the present invention is not limited to the plurality of illustrated examples described above, but may be modified in various manners without departing from the spirit of the invention.

1. A measuring instrument having a web server function, the measuring instrument, comprising:
a) control means for controlling an operation of the measuring instrument,
b) storage means for storing measurement condition data,
c) measuring means for performing a measurement based on the measurement condition data,
d) receiving means for receiving request data from a client device, and
e) transmitting means for transmitting web data to the client device,
wherein a) the control means i) controls the transmitting means so as to transmit web data corresponding to a remote control web page when the request data is request data for requesting transmission of the remote control web page, and
a) the control means ii) controls the storage means so as to store the measurement condition data corresponding to the request data when the request data is request data for requesting a setting of a measurement condition.

2. The measuring instrument according to claim 1, wherein a) the control means creates the web data so that the remote control web page permits a user of the client device to input measurement condition data.

3. The measuring instrument according to claim 1, wherein a) the control means creates the web data so that the remote control web page permits a user of the client device to select measurement condition data.

4. The measuring instrument according to claim 3, wherein a) the control means creates the web data so that the remote control web page further displays an image and coordinates on the image are transmitted as the measurement condition data in response to the user's click on the image.

5. The measuring instrument according to claim 2, wherein a) the control means creates the web data so that the remote control web page further displays actually set measurement condition data.

6. The measuring instrument according to claim 4, wherein a) the control means creates the web data so that the remote control web page further displays the image for visualizing actually set measurement condition data.

7. The measuring instrument according to claim 3, wherein a) the control means creates the web data so that the remote control web page further displays actually set measurement condition data.

8. The measuring instrument according to claim 4, wherein a) the control means creates the web data so that the remote control web page further displays actually set measurement condition data.
